(19) United States
(12) Patent Application Publication
(10) Pub. No.: US 2026/0194259 A1
(43) Pub. Date: Jul. 9, 2026

(54) WATER HEATER APPLIANCE FREEZE PREVENTION IN RECREATIONAL VEHICLES

(71) Applicant: Haier US Appliance Solutions, Inc., Wilmington, DE (US)

(72) Inventors: Andrew Scott Hapner, Findlay, OH (US); Richard Dustin Henderson, La Grange, KY (US); Jacob Strader, La Grange, KY (US)

(21) Appl. No.: 19/014,334

(22) Filed: Jan. 9, 2025

(51) Int. Cl. F24H 15/136; B60P 3/36; F24H 1/00; F24H 15/212

(52) U.S. Cl. CPC F24H 15/136; B60P 3/36; F24H 1/009; F24H 15/212

(57) ABSTRACT

A water heater appliance includes a cabinet, and a heat exchanger positioned within the cabinet. A combustion chamber is positioned within the cabinet. The combustion chamber includes a burner assembly. The combustion chamber is in thermal communication with the heat exchanger. The water heater appliance also includes an inlet and an outlet coupled to the cabinet, and a freeze prevention circuit. The freeze prevention circuit is configured to detect a specified temperature within the water heater appliance and activate one of a heater and the heat exchanger of the water heater appliance in response to the detection of the specified temperature.

### FIELD OF THE INVENTION

The present subject matter relates generally to recreational vehicle water heaters, and more particularly to freeze prevention systems therein.

### BACKGROUND OF THE INVENTION

Water heaters for use with recreational vehicles (RV) typically include a water tank in combination with an internal heating element. Most internal heating elements in water heaters used in recreational vehicles are dual fuel: liquid petroleum gas and electric heating. The water heater is mounted on the recreational vehicle in a convenient position connected to cold water supply and hot water outlet pipes, respectively receiving cold water from a suitable water supply source and for directing heated water for use in cooking, bathing, and the like.

Standard recreational vehicle water heaters include an exhaust tube to the outside air in order to exhaust combustion products from the water heater out of the recreational vehicle. In colder climates, such as climates reaching temperatures below forty degrees Fahrenheit (40°F), water heater appliances may be at risk of freezing and/or being damaged by cold air. When not using the water heater appliance, there are two typical ways that users prevent freezing of the water heater; either by draining the water completely from the recreational vehicle or by filling the pipes with an anti-freeze liquid (also known as winterization).

However, problems may occur either when driving in sub-freezing conditions, or if overnight the temperature drops below freezing and the water heater appliance is not maintaining temperature to prevent freezing. Another way that other tankless water heaters prevent freezing overnight is by running the heat exchanger to prevent freezing from occurring. This is done by propane flowing, being ignited, and passing through the heat exchanger to warm up the water heater appliance. However, typically propane is turned off when traveling, and constantly running the water heater appliance consumes a large amount of propane compared to regular operation.

Accordingly, a water heater appliance with a freeze prevention system that decreases cost would be desirable. Further, a recreational vehicle with a water heater appliance that includes a freeze prevention system that operates at any given time for freeze prevention, and decreases cost, would be advantageous.

### BRIEF DESCRIPTION OF THE INVENTION

Aspects and advantages of the invention will be set forth in part in the following description, or may be apparent from the description, or may be learned through practice of the invention.

In one example embodiment, a water heater appliance for a recreational vehicle is provided. The water heater appliance defines a vertical direction, a lateral direction, and a transverse direction. The vertical, lateral, and transverse directions are mutually perpendicular. The water heater appliance includes a cabinet, and a heat exchanger positioned within the cabinet. The heat exchanger includes a first temperature sensor. A combustion chamber is positioned within the cabinet. The combustion chamber includes a burner assembly. The combustion chamber is in thermal communication with the heat exchanger. The water heater appliance also includes an inlet coupled to the cabinet. The inlet includes an inlet tube fluidly coupled to the heat exchanger. The inlet tube includes an inlet temperature sensor. An outlet is coupled to the cabinet. The outlet includes an outlet tube fluidly coupled to the heat exchanger. The outlet tube includes an outlet temperature sensor and an outlet heater.

In another example embodiment, a water heater appliance for a recreational vehicle is provided. The water heater appliance defines a vertical direction, a lateral direction, and a transverse direction. The vertical, lateral, and transverse directions are mutually perpendicular. The water heater appliance includes a cabinet, and a heat exchanger positioned within the cabinet. A combustion chamber is positioned within the cabinet. The combustion chamber includes a burner assembly. The combustion chamber is in thermal communication with the heat exchanger. The water heater appliance also includes an inlet and an outlet coupled to the cabinet, and a freeze prevention circuit. The freeze prevention circuit is configured to detect a specified temperature within the water heater appliance and activate one of a heater and the heat exchanger of the water heater appliance in response to the detection of the specified temperature.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an example embodiment of a water heater appliance for a recreational vehicle, according to aspects of the present subject matter.

FIG. 2 provides a perspective view of the water heater appliance of FIG. 1, with a door of the water heater appliance removed, according to aspects of the present subject matter.

FIG. 3 provides a perspective, sectional view of the water heater appliance of FIG. 1, according to aspects of the present subject matter.

FIG. 4 provides a side view of the water heater appliance of FIG. 1, according to aspects of the present subject matter.

FIG. 5 provides another side view of the water heater appliance of FIG. 1, according to aspects of the present subject matter.

FIG. 6 provides a schematic diagram of a freeze prevention circuit, according to aspects of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified.

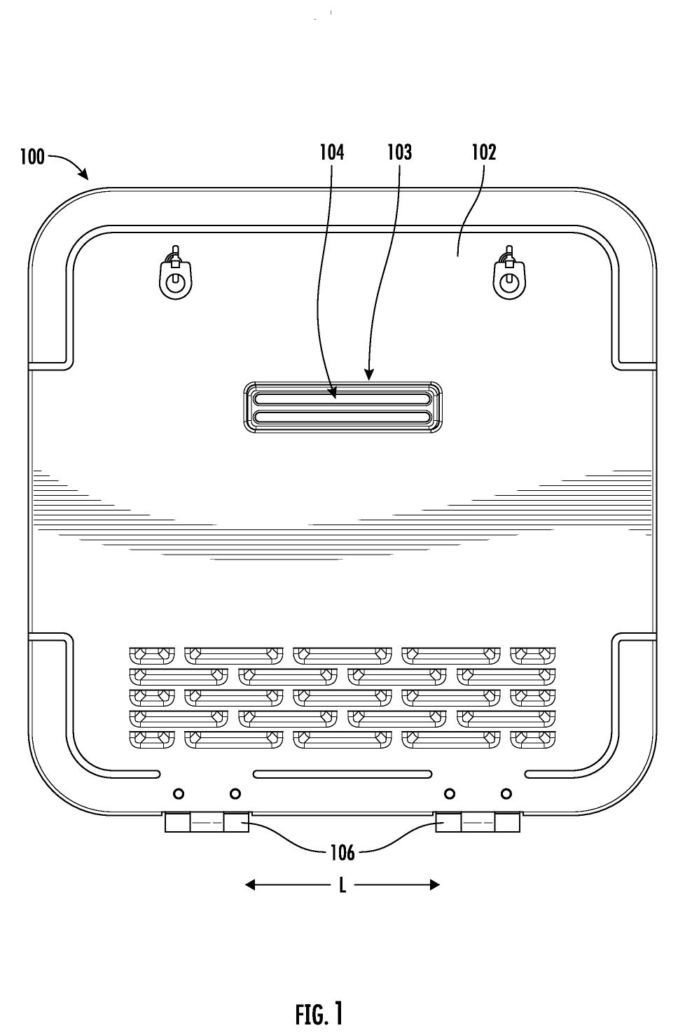

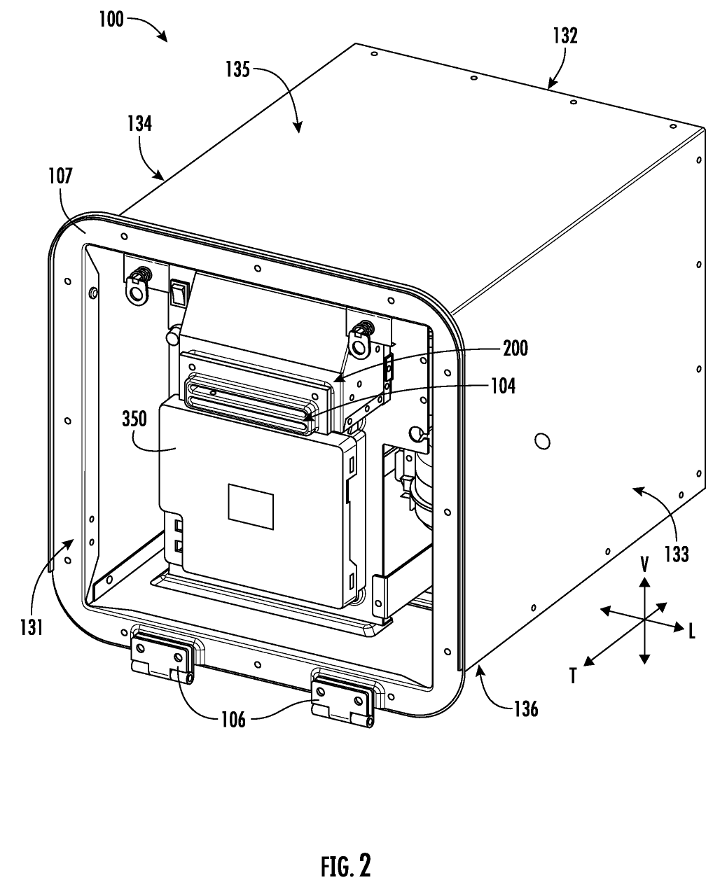

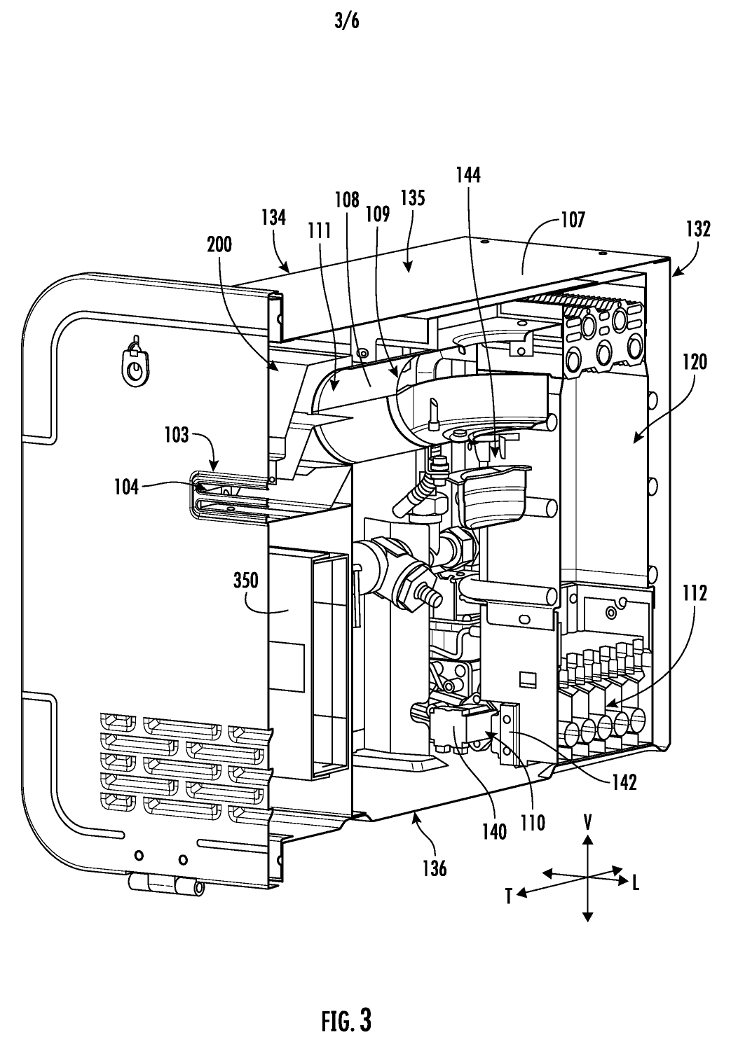

Referring now to FIGS. 1 through 3, an example water heater appliance will be described in accordance with example aspects of the present subject matter. Specifically, FIG. 1 provides a front view of an example water heater appliance 100, FIG. 2 provides a perspective view of water heater appliance 100, and FIG. 3 provides a perspective, cross-sectional view of water heater appliance 100. As illustrated, water heater appliance 100 generally defines a vertical direction V, a lateral direction L, and a transverse direction T, each of which is mutually perpendicular, such that an orthogonal coordinate system is generally defined.

According to example embodiments, water heater appliance 100 may include a cabinet 107 that is generally configured for containing and/or supporting various components of water heater appliance 100 and which may also define one or more internal chambers or compartments of water heater appliance 100. In this regard, as used herein, the terms “cabinet,” “housing,” and the like are generally intended to refer to an outer frame or support structure for appliance 100, e.g., including any suitable number, type, and configuration of support structures formed from any suitable materials, such as a system of elongated support members, a plurality of interconnected panels, or some combination thereof. It should be appreciated that cabinet 107 does not necessarily require an enclosure and may simply include an open structure supporting various elements of appliance 100. By contrast, cabinet 107 may enclose some or all portions of the interior of cabinet 107. It should be appreciated that cabinet 107 may have any suitable size, shape, and configuration while remaining within the scope of the present subject matter.

In general, cabinet 107 may extend in the transverse direction T between a front side 131 and a back side 132, in the vertical direction V between a top side 135 and a bottom side 136, and in the lateral direction L between a first side 133 and a second side 134. In general, water heater appliance 100 may include a panel, e.g., a door 102, coupled to cabinet 107, as shown in FIG. 1 in a closed position, and removed in FIG. 2 for clarity in showing within cabinet 107. In general, door 102 may be mounted to cabinet 107 via hinges 106, e.g., hinges 106 may rotatably couple door 102 to cabinet 107. Opening door 102 about hinge 106 may permit selective access to internal components within cabinet 107, such as a burner assembly 110, a heat exchanger 120 and/or, an exhaust box 200, each of which are described in greater detail below. In general, door 102 of water heater appliance 100 may include a slot, such as an exhaust port 103, for an exhaust outlet 104, as will be described in greater detail below.

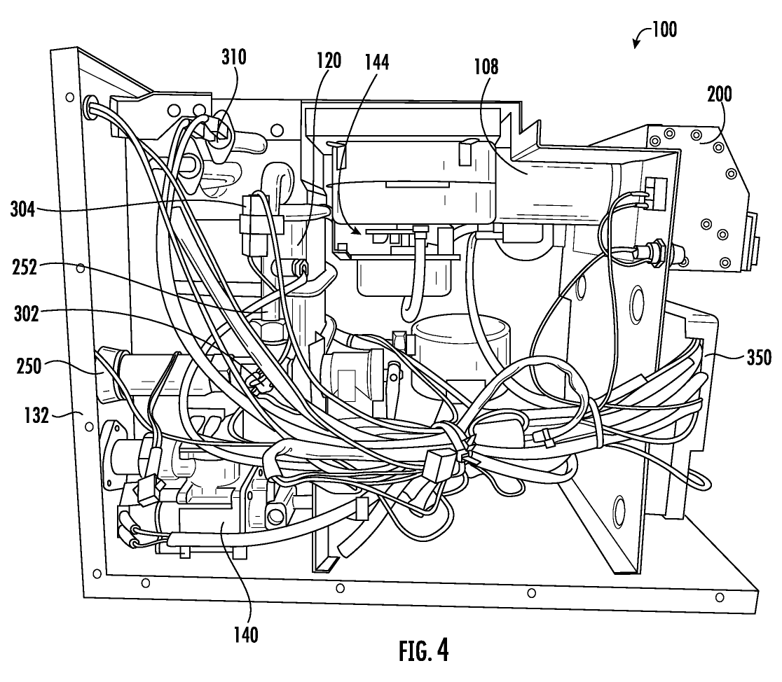

In the present example embodiment, water heater appliance 100 may include a heat exchanger 120 positioned within cabinet 107. Heat exchanger 120 may generally provide heat to water flowing through water heater appliance 100. For example, water heater appliance 100 may be a dual-fuel water heater. Thus, water heater appliance 100 may be configured for heating water by combusting liquid petroleum gas, such as liquid propane (LP). As will be explained further below, heat exchanger may include a first temperature sensor 310 (FIG. 4). In general, water heater appliance 100 may also include a combustion chamber 112 within cabinet 107 for combusting liquid propane. As such, combustion chamber 112 may include a burner assembly 110 extending therein, and combustion chamber 112 may be in thermal communication with heat exchanger 120. In general, burner assembly 110 may include a gas inlet (not labeled) and a sparker or igniter 142 for igniting fuel within combustion chamber 112. In other words, burner assembly 110 may combust fuel within combustion chamber 112, thus providing heat to heat exchanger 120 for heating water passing through water heater appliance 100. Accordingly, water may enter water heater appliance 100 and be heated by heat exchanger 120, before being distributed to other appliances or outlets for use in cooking, bathing, and the like.

In general, burner assembly 110 may be in fluid communication with a gas control valve 140 to control the flow of gas to combustion chamber 112. Burner assembly 110 may generally create combustion products, such as exhaust gases within combustion chamber 112. In general, the created combustion products may exit water heater appliance 100 to ambient atmosphere. In particular, water heater appliance 100 may include an exhaust tube 108 fluidly coupled to combustion chamber 112. For example, exhaust tube 108 may extend between an inlet 109 positioned at combustion chamber 112 and an outlet 111 along the transverse direction T. In some example embodiments, a blower assembly 144 may be fluidly coupled between combustion chamber 112 and exhaust tube 108. Blower assembly 144 may generally be configured to pull exhaust from heat exchanger 120, through exhaust tube 108, and force the exhaust out of water heater appliance 100 to ambient atmosphere.

In the present example embodiment, an exhaust box 200 may be positioned at outlet 111 of exhaust tube 108. Exhaust box 200 may generally be a rectangular, stainless-steel box. In particular, exhaust box 200 may be fluidly coupled to exhaust tube 108 and may include exhaust outlet 104, e.g., exhaust outlet 104 may be integral to exhaust box 200 and may extend through exhaust port 103 in door 102 of water heater appliance 100. As such, the created combustion products from burner assembly 110 may exit from water heater appliance 100 to ambient atmosphere from combustion chamber 112 through exhaust tube 108, into exhaust box 200, and through exhaust outlet 104.

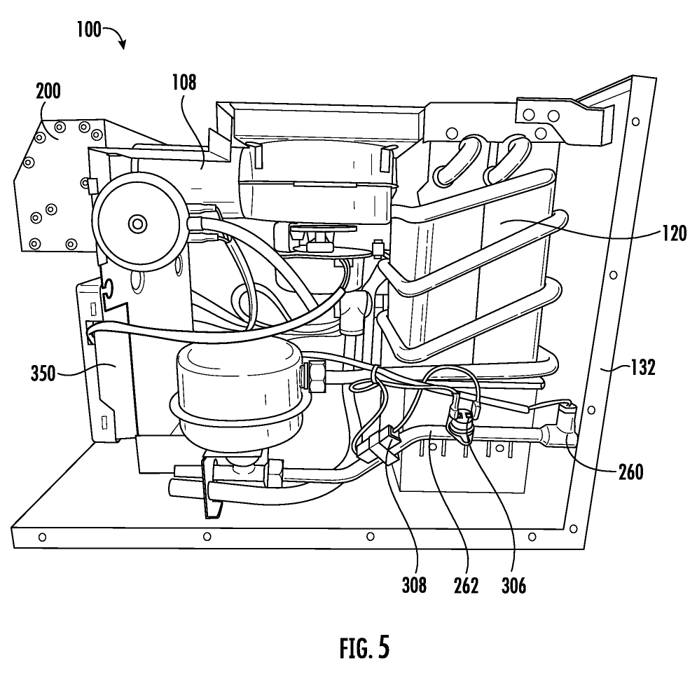

Turning now to FIGS. 4 and 5, provided are side views of water heater appliance 100, with portions of cabinet 107 removed for clarity of the components within water heater appliance 100. In general, water heater appliance 100 may include an inlet 250 coupled to cabinet 107. For example, inlet 250 may be coupled to and extend through back side 132 of cabinet 107. In general, inlet 250 may be coupled to an inlet tube 252, e.g., within cabinet 107 inlet 250 may be fluidly coupled to inlet tube 252. Inlet tube 252 may generally be fluidly coupled to heat exchanger 120, thereby extending between inlet 250 and heat exchanger 120. As such, water heater appliance 100 may receive water from an external water source, such as a water tank or a municipal water supply, through inlet 250 and direct the water into heat exchanger 120 for heating. As will be explained further below, inlet tube 252 may include an inlet temperature sensor 302 mounted thereon and an inlet heater 304 mounted thereon.

In general, water heater appliance 100 may include an outlet 260 coupled to cabinet 107. For example, outlet 260 may be coupled to and extend through back side 132 of cabinet 107. In general, outlet 260 may be coupled to an outlet tube 262, e.g., within cabinet 107 outlet 260 may be fluidly coupled to outlet tube 262. Outlet tube 262 may generally be fluidly coupled to heat exchanger 120, thereby extending between heat exchanger 120 and outlet 260. As such, water heater appliance 100 may distribute water, e.g., heated water from heat exchanger 120, out of outlet 260 to various points of use, such as other appliances, such as a dishwasher appliance or washing machine appliance, or other points of use, including fixtures such as faucets, etc. For example, some recreational vehicles include a plurality of appliances therein, and water heater appliance 100 may be configured to supply heated water thereto. As will be explained further below, outlet tube 262 may include an outlet temperature sensor 306 mounted thereon and an outlet heater 308 mounted thereon.

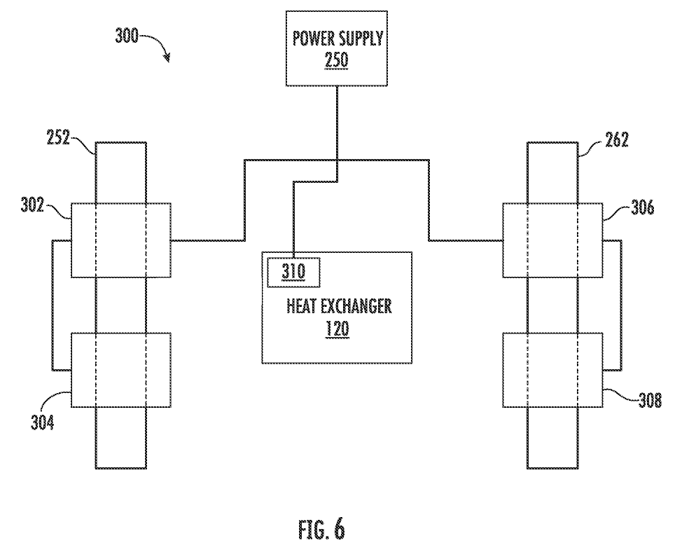

Turning now to FIG. 6, provided is a schematic diagram of a freeze prevention circuit 300 of water heater appliance 100. In general, freeze prevention circuit 300 may include first temperature sensor 310 of heat exchanger 120, inlet temperature sensor 302 of inlet tube 252, inlet heater 304 of inlet tube 252, outlet temperature sensor 306 of outlet tube 262, and outlet heater 308 of outlet tube 262. In general, freeze prevention circuit 300 may be an analog circuit, e.g., distinct and separate from a controller (not shown) or microprocessor of water heater appliance 100. In particular, water heater appliance 100 may include a power supply 350 electrically coupled to freeze prevention circuit 300, such that power may be provided to freeze prevention circuit 300 and transmitted to the components thereof.

In general, inlet temperature sensor 302 may be electrically coupled in series with inlet heater 304, outlet temperature sensor 306 may be electrically coupled in series with outlet heater 308, and first temperature sensor 310 may be electrically coupled in series with heat exchanger 120. In particular, each of inlet temperature sensor 302 and inlet heater 304, outlet temperature sensor 306 and outlet heater 308, as well as first temperature sensor 310 and heat exchanger 120 may be independent circuits coupled to power supply 350. In general, first temperature sensor 310, inlet temperature sensor 302, and outlet temperature sensor 306 may be thermal switches. In particular, thermal switches may be electromechanical switches which open and close metallic contacts, in response to changes in temperature, to control the flow of electrical current. For example, when the temperature increases above a specified temperature, a thermal switch may open, thereby cutting off current to components further down a circuit. In the present example embodiment, when the temperature of either of first temperature sensor 310, inlet temperature sensor 302, or outlet temperature sensor 306 drops below a specified, threshold temperature, the circuit may close, thereby providing current to the component or components connected in series to the respective sensor at which the sensed temperature dropped below the threshold temperature. As such, inlet temperature sensor 302, outlet temperature sensor 306, and first temperature sensor 310 may be analog components. Further, inlet heater 304 and outlet heater 308 may be resistive heaters, e.g., analog components, such that freeze prevention circuit 300 may consist of only analog components.

In general, freeze prevention circuit 300 may be configured to detect a specified temperature within water heater appliance 100, and activate one of inlet heater 304, outlet heater 308, and heat exchanger 120 of water heater appliance 100 in response to the detection of the specified temperature. In particular, the specified temperature may include a threshold temperature, such as about fifty degrees Fahrenheit (50°F) or less, such as about forty-five degrees Fahrenheit (45°F) or less, such as about forty degrees Fahrenheit (40°F), wherein detecting the specified temperature includes detecting a temperature below the threshold temperature. For example, outlet temperature sensor 306 may detect a temperature below the threshold, e.g., below about forty degrees Fahrenheit (40°F), wherein outlet temperature sensor 306 may close and permit current/power to flow to outlet heater 308, thereby heating outlet tube 262 to restrain water within outlet tube 262 from freezing.

In other words, heat exchanger 120 may be activated in response to first temperature sensor 310 detecting the temperature below the specified/threshold temperature. In general, activating heat exchanger 120 via freeze prevention circuit 300 may include releasing and igniting gas within combustion chamber 112 of heat exchanger 120 to, by convection and conduction, heat up heat exchanger 120, thus restraining water within heat exchanger 120 from freezing. Additionally or alternatively, outlet heater 308 may be activated in response to outlet temperature sensor 306 detecting the temperature below the specified/threshold temperature. Additionally or alternatively, inlet heater 304, on inlet tube 252, of freeze prevention circuit 300 may be configured to activate in response to inlet temperature sensor 302 detecting the specified/threshold temperature, thus restraining water within inlet tube 252 from freezing. In some example embodiments, heat exchanger 120 may be disconnected from freeze prevention circuit 300 such that heat exchanger 120 is not activated, e.g., gas is not released and/or ignited within combustion chamber 112, which may be advantageous, such as while driving a recreational vehicle that water heater appliances is mounted therein.

As such, when the temperature of inlet tube 252, heat exchanger 120, and/or outlet tube 262 within water heater appliance 100 is detected to be below the specified/threshold temperature, freeze prevention circuit 300 may be configured to activate inlet heater 304 (e.g., in response to inlet temperature sensor 302 on inlet tube 252), heat exchanger 120 (e.g., in response to first temperature sensor 310 on heat exchanger 120), and outlet heater 308 (e.g., in response to outlet temperature sensor 306 on outlet tube 262). Accordingly, freeze prevention circuit 300 may aid in preventing water heater appliance 100 from freezing between inlet 250, heat exchanger 120, and outlet 260 with electricity and without the use of a controller/microprocessor.

As may be seen from the above, a water heater appliance for a recreational vehicle may include a freeze prevention circuit including thermal switches and heaters connected in series, such that the heaters may be activated upon the thermal switches detecting a temperature below a threshold temperature. Accordingly, the above water heater appliance may advantageously decrease costs by decreasing overall gas usage and eliminating filling the water heater appliance with anti-freeze liquid, while also providing a freeze prevention system that may operate at any given time, including while driving a recreational vehicle that water heater appliances is mounted therein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water heater appliance for a recreational vehicle, the water heater appliance defining a vertical direction, a lateral direction, and a transverse direction, the vertical, lateral, and transverse directions mutually perpendicular, the water heater appliance comprising:
a cabinet;
a heat exchanger positioned within the cabinet, the heat exchanger comprising a first temperature sensor;
a combustion chamber positioned within the cabinet, the combustion chamber comprising a burner assembly, the combustion chamber in thermal communication with the heat exchanger;
an inlet coupled to the cabinet, the inlet comprising an inlet tube fluidly coupled to the heat exchanger, the inlet tube comprising an inlet temperature sensor; and
an outlet coupled to the cabinet, the outlet comprising an outlet tube fluidly coupled to the heat exchanger, the outlet tube comprising an outlet temperature sensor and an outlet heater.

2. The water heater appliance of claim 1, wherein a freeze prevention circuit comprises the first temperature sensor of the heat exchanger, the inlet temperature sensor of the inlet tube, the outlet temperature sensor of the outlet tube, and the outlet heater of the outlet tube.

3. The water heater appliance of claim 2, further comprising an inlet heater coupled to the inlet tube, wherein the freeze prevention circuit comprises the inlet heater of the inlet tube.

4. The water heater appliance of claim 2, wherein the freeze prevention circuit is configured to:
detect a specified temperature within the water heater appliance, and
activate one of the outlet heater and the heat exchanger of the water heater appliance in response to the detection of the specified temperature.

5. The water heater appliance of claim 4, wherein the specified temperature comprises a threshold temperature, wherein detecting the specified temperature comprises detecting a temperature below the threshold temperature.

6. The water heater appliance of claim 4, wherein activating one of the outlet heater and the heat exchanger of the water heater appliance comprises one or more of activating the heat exchanger in response to the first temperature sensor detecting the temperature below the specified temperature, and activating the outlet heater in response to the outlet temperature sensor detecting the specified temperature.

7. The water heater appliance of claim 4, wherein the freeze prevention circuit is configured to activate an inlet heater of the inlet tube in response to the first temperature sensor detecting the specified temperature.

8. The water heater appliance of claim 2, wherein the freeze prevention circuit is an analog circuit consisting of analog components.

9. The water heater appliance of claim 2, further comprising a power supply electrically coupled to the freeze prevention circuit.

10. A water heater appliance for a recreational vehicle, the water heater appliance defining a vertical direction, a lateral direction, and a transverse direction, the vertical, lateral, and transverse directions mutually perpendicular, the water heater appliance comprising:
a cabinet;
a heat exchanger positioned within the cabinet;
a combustion chamber positioned within the cabinet, the combustion chamber comprising a burner assembly, the combustion chamber in thermal communication with the heat exchanger;
an inlet and an outlet coupled to the cabinet; and
a freeze prevention circuit configured to:
detect a specified temperature within the water heater appliance, and
activate at least one of a heater and the heat exchanger of the water heater appliance in response to the detection of the specified temperature.

11. The water heater appliance of claim 10, wherein the heat exchanger comprises a first temperature sensor, wherein the freeze prevention circuit comprises the first temperature sensor of the heat exchanger.

12. The water heater appliance of claim 10, wherein the inlet comprises an inlet tube fluidly coupled to the heat exchanger, the inlet tube comprising an inlet temperature sensor, wherein the freeze prevention circuit comprises the inlet temperature sensor of the inlet tube.

13. The water heater appliance of claim 12, further comprising an inlet heater coupled to the inlet tube, wherein the freeze prevention circuit comprises the inlet heater of the inlet tube.

14. The water heater appliance of claim 13, wherein the freeze prevention circuit is configured to activate the inlet heater of the inlet tube in response to the inlet temperature sensor detecting the specified temperature.

15. The water heater appliance of claim 10, wherein the outlet comprises an outlet tube fluidly coupled to the heat exchanger, the outlet tube comprising an outlet temperature sensor and an outlet heater, wherein the freeze prevention circuit comprises the outlet temperature sensor and the outlet heater of the outlet tube.

16. The water heater appliance of claim 15, wherein activating one of the outlet heater and the heat exchanger of the water heater appliance comprises one or more of activating the heat exchanger in response to the first temperature sensor detecting the temperature below the specified temperature, and activating the outlet heater in response to the outlet temperature sensor detecting the specified temperature.

17. The water heater appliance of claim 10, wherein the specified temperature comprises a threshold temperature, wherein detecting the specified temperature comprises detecting a temperature below the threshold temperature.

18. The water heater appliance of claim 10, wherein the freeze prevention circuit is an analog circuit consisting of analog components.

19. The water heater appliance of claim 10, further comprising a power supply electrically coupled to the freeze prevention circuit.
